(19) United States
(12) Patent Application Publication
(10) Pub. No.: US 2021/0374628 A1
(43) Pub. Date: Dec. 2, 2021

(54) SYSTEMS AND METHODS FOR VISUAL FINANCIAL MODELING

(71) Applicant: Proforma Technologies, Inc., Omaha, NE (US)

(72) Inventors: Leandro S. Castro, Elkhorn, NE (US); Carissa B. Castro, Elkhorn, NE (US)

(21) Appl. No.: 17/352,787

(22) Filed: Jun. 21, 2021

Related U.S. Application Data
(63) Continuation of application No. PCT/US21/33262, filed on May 19, 2021.
Application No. PCT/US21/33262 is a continuation-in-part of application No. 29/770,775, filed on Feb. 16, 2021.
(60) Provisional application No. 63/027,709, filed on May 20, 2020.

(51) Int. Cl. G06Q 10/06; G06F 9/451; G06F 7/544

(52) U.S. Cl. CPC G06Q 10/067; G06F 7/544; G06F 9/451

(57) ABSTRACT

The present disclosure provides systems, methods, and computer program products for building and displaying a financial model in a graphical user interface. An example method can comprise (a) displaying a plurality of graphical elements representing a plurality of variables and a plurality of functions and (b) providing an electronic canvas in which to build a graphical representation of the financial model using at least a subset of the plurality of graphical elements. The subset of graphical elements can comprise graphical elements that represent at least an input variable and a computed variable. The method can further comprise (c) upon a user building the graphical representation of the financial model, automatically interpreting and executing the financial model to compute the computed variable; and (d) displaying an interactive chart of the input variable and the computed variable. The interactive chart can enable the user to define a value of the input variable.

### CROSS-REFERENCE

This application is a continuation application of International Application No. PCT/US2021/033262, filed May 19, 2021, which application claims priority to U.S. Provisional Application No. 63/027,709, filed on May 20, 2020, and which is a continuation-in-part of U.S. Design application No. 29/770,775, filed on Feb. 16, 2021, each of which is incorporated herein by reference in its entirety.

### BACKGROUND

Financial modeling is the process of building an abstract representation of a financial situation. Financial models may take one or more inputs (e.g., revenue, cost of goods sold, and expenses) and predict one or more outputs (e.g., profit). Entities such as governments, businesses, and non-profit organizations may use financial models to predict the financial performance of a particular asset or portfolio of assets, a project, or the entity as a whole. Financial models may include project finance models, capital budgeting models, cash flow models, profit models, business valuation models, scenario planning models, and the like. Financial models may be built in a spreadsheet program (e.g., Microsoft Excel®).

### SUMMARY

The present disclosure provides systems, methods, and computer program products for building and displaying financial models in a graphical user interface of a computing device. The graphical user interface may have graphical elements that represent variables and functions. The variables may include input variables and computed variables. The functions may include algebraic functions or mathematical operations. The graphical elements may be moveable and connectable within the graphical user interface. A user can build a graphical representation of a financial model in the graphical user interface by connecting graphical elements that represent variables to graphical elements that represent functions. Upon the user partially or completely building the graphical representation of the financial model, the computing device on which the graphical user interface is implemented can interpret and execute the financial model to compute the computed variables in the financial model. The graphical user interface may also display an interactive chart of the input variables and the computed variables. The interactive chart may include plot lines or similar visual elements that show the values of the variables over time. The plot lines may enable a user to define or adjust the values of input variables in different time intervals, e.g., by dragging corresponding plot lines along the y-axis of the interactive chart. The computing device can automatically reinterpret and re-execute the financial model upon the user taking such an action, which may cause other plot lines in the interactive chart to change.

Building a financial model in the graphical user interface described above may be less cumbersome than building the same financial model in a spreadsheet program. The graphical user interface may be more intuitive to use, may enable a user to more clearly see relationships between input variables and computed variables, and may enable the user to view and interact with output visualizations that are generated in real-time as the graphical representation of the financial model is updated.

In an aspect, the present disclosure provides a method for building and displaying a financial model in a graphical user interface. The method can comprise (a) displaying, in the graphical user interface, a plurality of graphical elements representing a plurality of variables and a plurality of functions; (b) providing, in the graphical user interface, an electronic canvas in which to build a graphical representation of the financial model using at least a subset of the plurality of graphical elements. The subset of graphical elements can comprise graphical elements that represent at least an input variable and a computed variable. The method can further comprise (c) upon a user building the graphical representation of the financial model in the electronic canvas using the subset of graphical elements, automatically interpreting and executing the financial model to compute the computed variable; and (d) displaying, in the graphical user interface, an interactive chart of the input variable and the computed variable. The interactive chart can enable the user to define or adjust at least a value of the input variable.

In some embodiments, the method comprises, upon the user adjusting the value of the input variable in the interactive chart, automatically re-executing the financial model and updating the interactive chart to reflect the adjustment. In some embodiments, the subset of graphical elements comprises graphical elements that represent a plurality of computed variables, and the re-executing comprises determining a subset of the plurality of computed variables that are not affected by the user adjusting the value of the input variable, and the re-executing does not comprise re-computing the subset of computed variables. In some embodiments, the method comprises displaying the electronic canvas and the interactive chart in the graphical user interface simultaneously. In some embodiments, the electronic canvas enables the user to select and connect the subset of graphical elements to build the graphical representation of the financial model. In some embodiments, the plurality of functions comprises a mathematical operation. In some embodiments, the plurality of functions comprises an algebraic function. In some embodiments, the plurality of variables comprises a plurality of financial variables. In some embodiments, the interactive chart comprises plot lines of the input variable and the computed variable over time. In some embodiments, the plot line of the input variable enables the user to define or adjust a value of the input variable in a plurality of different time intervals by dragging the plot line of the input variable. In some embodiments, the plot lines of the input variable and the computed variable are color-coded to the graphical elements that represent the input variable and the computed variable. In some embodiments, the electronic canvas is a drag and drop interface. In some embodiments, the method comprises, displaying, in the graphical user interface, an interactive table of the input variable upon selection of the graphical element that represents the input variable in the electronic canvas. In some embodiments, the interactive table enables the user to define or adjust a value of the input variable in a plurality of different time intervals. In some embodiments, a value of the input variable is obtained from an external data source. In some embodiments, the graphical representation of the financial model is a flow chart. In some embodiments, the interactive chart comprises bar charts of the input variable and the computed variable. In some embodiments, the method comprises, displaying in the graphical user interface, an interactive input form for the input variable upon selection of the graphical element that represents the input variable. In some embodiments, the form enables the user to define or adjust a name, source, growth rate, growth type, or periodicity of the input variable in a plurality of different time intervals. In some embodiments, the graphical user interface is implemented on a platform accessible by a plurality of users including the user, wherein each of the plurality of users is permitted to edit the graphical representation of the financial model in the electronic canvas. In some embodiments, the method comprises storing a history of changes to the financial model. In some embodiments, the subset of graphical elements is reusable to build a plurality of financial models including the financial model. In some embodiments, the method comprises automatically generating a financial report based on the financial model. In some embodiments, a data structure representation of the financial model is a graph.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a graphical user interface for building and displaying a financial model, according to some embodiments of the present disclosure;

FIG. 2 is a flow chart of a process for building and displaying a financial model in a graphical user interface, according to some embodiments of the present disclosure;

FIG. 3 shows a computer system that is programmed or otherwise configured to implement methods provided herein;

FIG. 4 illustrates a canvas view of the graphical user interface of FIG. 1, according to some embodiments of the present disclosure;

FIG. 5 illustrates an enlarged canvas view of the graphical user interface of FIG. 1 in which a graphical element is selected, according to some embodiments of the present disclosure;

FIG. 6 illustrates an alternative embodiment to the graphical user interface of FIG. 1; and

FIG. 7 illustrates a canvas and table view of the of the graphical user interface of FIG. 1, according to some embodiments of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “financial model,” as used herein, generally refers to a mathematical model that represents or predicts the performance of a financial asset. The financial asset may be a project, a business, a portfolio, a fund, a trust, or the like. Examples of financial models are project finance models, capital budgeting models, cash flow models, profit models, business valuation models, scenario planning models, and the like.

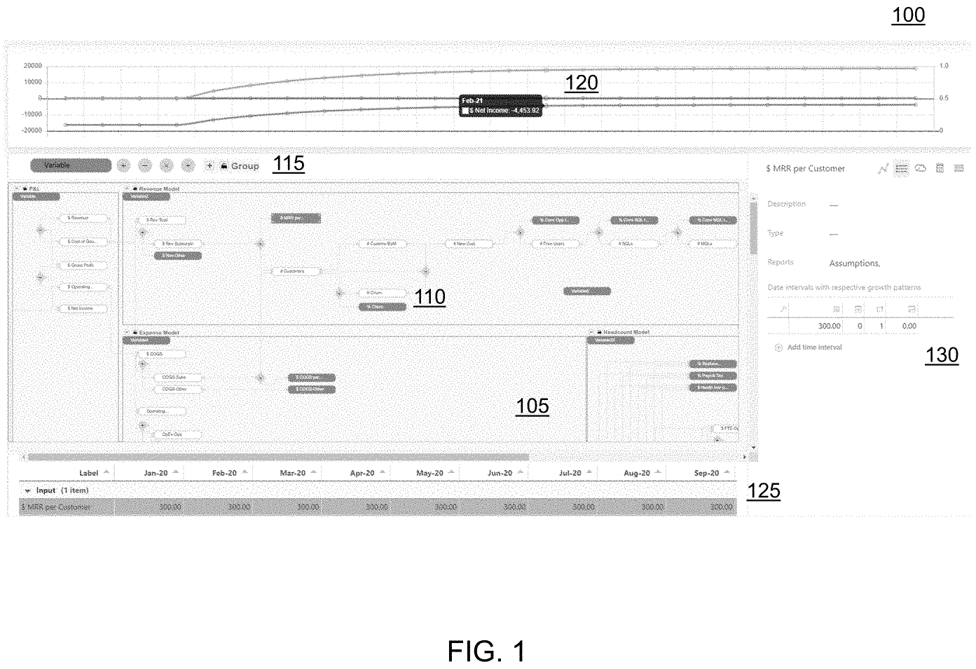

FIG. 1 illustrates a graphical user interface 100 for building and displaying a financial model, according to some embodiments of the present disclosure. The graphical user interface may include an electronic canvas 105, graphical elements 110 and 115 that represent variables and functions, an interactive chart 120, an interactive table 125, and an interactive input form 130.

The graphical user interface 100 may be implemented on a computing device with an electronic display. The computing device may be a mobile device, an electronic tablet, a laptop or desktop computer, or the like. The electronic display of the computing device may be a touch screen. The touch screen may enable a user to interact with the graphical user interface 100 using touch inputs. Alternatively, the computing device may have an electronic display without touch capabilities that is connected to one or more peripheral devices (e.g., a keyboard or mouse). The peripheral devices may enable the user to interact with interactive elements of the graphical user interface 100. The user may additionally or alternatively interact with the graphical user interface using voice inputs. In some cases, the user may user a combination of touch, peripheral device, and voice inputs to interact with the graphical user interface 100.

The computing device may have a general-purpose processor, graphics processing units (GPU), application-specific integrated circuits (ASIC), field-programmable gate-arrays (FPGA), or the like. The computing device may additionally have memory, e.g., dynamic or static random-access memory, read-only memory, flash memory, a hard drive, or the like. The memory can be configured to store instructions that, upon execution, cause the computing device to implement the graphical user interface 100 and associated functionality.

The computing device may additionally have network communication devices. The network communication devices may enable the computing device to communicate with external data sources or servers over a network. The network can be a wired or wireless network. For example, the network can be a fiber optic network, Ethernet® network, a satellite network, a cellular network, a Wi-Fi® network, a Bluetooth® network, or the like.

The electronic canvas 105 of the graphical user interface 100 may be a virtual space for building a graphical representation of a financial model. The electronic canvas 105 may comprise whitespace. A user can build the graphical representation of the financial model in the whitespace of the electronic canvas 105 using a subset of the graphical elements 110 and 115. The user can select, drag, and drop desired graphical elements into the electronic canvas 105. Alternatively, the user can double-click on desired graphical elements, which may cause such graphical elements to appear in the electronic canvas 105. Thereafter, the user can drag and drop the graphical elements within the electronic canvas 105.

In some cases, the graphical user interface 100 may include a search function. The search function may enable the user to search for desired graphical elements. Selection of a particular graphical element in the search results may cause that graphical element to appear in the electronic canvas 105. In some cases, the electronic canvas 105 may be prepopulated with common graphical elements or graphical elements associated with a particular template selected by the user. For example, if the user selected a profit model template, the electronic canvas 105 may be prepopulated with graphical elements representing income and expense variables (e.g., revenue, cost of goods sold, expenses, etc.).

The user can connect a first graphical element to a second graphical element (e.g., a graphical element 110 representing a variable to a graphical element 115 representing a function) by drawing a line between the two graphical elements. The user can draw the line by selecting an anchor point on the first graphical element and dragging his cursor to an anchor point on the second graphical element. Alternatively, the user can select both graphical elements and subsequently execute a “line” function in the graphical user interface 100. Selection of the line function button may cause the graphical user interface 100 to generate the line and automatically route the line from one graphical element to the other. The line may indicate a causal relationship between two variables represented by the graphical elements, or it may indicate that a variable represented by one graphical element serves as an input to a function represented by the other graphical element. The line may have an arrow that indicates the direction of causality or input. In this regard, the graphical representation of the financial model may be or represent a flow chart.

By selecting the line between two connected graphical elements, the user can define how the variable or function represented by one of the graphical elements interacts with the variable or function represented by the other graphical element. In some cases, the user can define the details of a relationship between two variables, such as a multiplier, time shift, or the specific time steps being referred to at the variables on either end of the line. For example, the user can define a multiplier between a sales representative variable and a customer variable. The multiplier may represent the quantity of customers that each sales representative is expected to generate. The user can additionally or alternatively define a time shift between the sales representative variable and the customer variable to model a delay in the relationship between the two variables. The delay may represent the quantity of time a sales representative is expected to take to generate a customer. The user can additionally or alternatively define a growth rate and growth type between the sales representative variable and the customer variable. The growth rate and growth type may together constitute a variable multiplier.

The graphical elements 110 may represent financial variables. The variables may be input variables (e.g., independent variables). The input variables used may depend on the type of financial model the user intends to build and can be customized accordingly. In the case of a profit model, the input variables may be quantity of customers, monthly recurring revenue per customer, cost of goods sold, salaries, expenses, and the like. In the case of a cash flow model, the input variables may be quantity of quantity of initial cash, issuance or repayment of debt, issuance or repayment of equity, net earnings, and the like. In the case of a business valuation model, the input variables may be revenue, net earnings, assets, headcount, and the like. In the case of a scenario planning model, the input variables may be drivers, uncertainty levels, time assumptions, growth assumptions, and the like. In the case of a project finance model, the input variables may be capital expenses, project expenses, and the like. In the case of a capital budgeting model, the input variables may be new asset costs, project expenses, target payback period, target internal rate of return, and the like.

The graphical user interface 100 may provide a library of common input variables for the user to choose. The input variables may be displayed in a menu in the graphical user interface 100. The menu may display only a subset of all available input variables. The menu may be expandable so that it displays all available input variables. Additionally, the graphical user interface may enable the user to create new input variables. The user can name such new variables and define their properties (e.g., value, periodicity, growth rate, growth type, etc.).

The variables may be computed variables (e.g., dependent variables). Computed variables may depend on one or more other variables and one or more functions. In the case of a project finance model, the computed variable may be the cost of a project. In the case of a capital budgeting model, the computed variable may be a binary computed indicative of whether an investment is worthwhile. In the case of a cash flow model, the computed variable may be cash on hand. In the case of a profit model, the computed variable may be profit. In the case of a business valuation model, the computed variable may be the value of the business.

Some variables may be both input and computed variables. Such variables may be outputs of one function and inputs to another. For example, one such variable in an income model may be cost of goods sold. Cost of goods sold may be an input to another variable (e.g., income) but may itself depend on other variables (e.g., quantity of goods sold and cost per unit). Some variables may be partially defined by the user and partially computed. For example, one such variable may be a quantity of customers. The user may manually define the quantity of customers for certain time periods (e.g., historical time periods) while using the graphical formulas and relationships drawn in the electronic canvas 105 to compute (i.e., estimate) the quantity of customers for future time periods.

The graphical elements 110 may represent functions. The functions may be mathematical operations, logical operations, flow control operations, or algebraic functions, for example. Examples of mathematical operations are addition, subtraction, multiplication, division, and the like. Examples of logical operations are AND, OR, XOR, and the like. Examples of flow control operations are IF, ELSE, SWITCH, FOR, WHILE. One example of an algebraic function is a tax function that accounts for progressive tax brackets.

A user can group two or more graphical elements together in the electronic canvas 105 by simultaneously selecting the two or more graphical elements and subsequently executing a “group” function. Executing the group function may cause the two or more graphical elements to be represented as one graphical element in the electronic canvas 105. Such abstraction may simplify the graphical representation of the financial model in the electronic canvas 105. A user may view the graphical elements that comprise an abstracted graphical element by selecting the abstracted graphical element in the electronic canvas 105. Graphical elements or groups of graphical elements may also be collapsible and expandable in the electronic canvas 105.

Upon a user completely building or partially building (e.g., by completely building one function of a multi-function model) a graphical representation of a financial model in the electronic canvas 105, the computing device on which the graphical user interface 100 is implemented can interpret and execute the graphical representation of the financial model to compute the computed variables in the financial model. Interpreting the graphical representation of the financial model may involve generating a mathematical function corresponding to the graphical representation and storing the mathematical function in memory. In order to improve efficiency, the interpreting algorithm may skip unnecessary calculations, by determining which variables are not directly or indirectly affected by the latest changes made to the model or its input variables. The computing device on which the graphical user interface 100 is implemented can store the financial model as a graph data structure. Executing the financial model may involve providing real-number inputs to the mathematical function and computing a result. The real-number inputs may be obtained from an external data source. The external data source may be, for example, accounting software for the business for which the financial model was created. The graphical user interface 100 and the external data source may communicate via an application programming interface (API). The graphical user interface 100 and the external data source may communicate in real-time. As inputs from the external data source change, the computing device can automatically update the outputs of the model.

The interactive chart 120 of the graphical user interface 100 may display visualizations of the input variables and the computed variables in the financial model. The graphical user interface 100 may simultaneously display the electronic canvas 105 and the interactive chart 120. When a user adds a graphical element representing an input variable to the electronic canvas 105, a visualization of the input variable may automatically and immediately appear in the interactive chart 120. The input variable may be initialized to zero. When the user updates the value of the input variable, the visualization may immediately (e.g., in real time) and automatically update to reflect the value. The visualizations of computed variables may be updated in a similar manner when the input variables on which they rely are updated. The visualizations of the input variables and computed variables may be plot lines, scatter plots, bar charts, histograms, or the like. In some cases, the interactive chart 120 may be an interactive spreadsheet with multiple tabs.

The visualizations of the input variables and the computed variables may show their values over time (e.g., in monthly time intervals). The user may define or change the value of an input variable by adjusting the visualization of the input variable. For example, the user may select and drag the plot line of an input variable in a direction parallel to the y-axis of the interactive chart 120 in order to change the value of the input variable. Dragging the plot line in the positive y-direction may cause the value of the input variable to increase, while dragging the plot line in the negative y-direction may cause the value of the input variable to decrease. The user may select and drag the plot line in only a single time interval, which may cause the input variable in that time interval to change. Alternatively, the user may select and drag the entire plot line, which may cause every value of the input variable to change. In other embodiments, the user may adjust the visualization of the input variable by directly selecting (e.g., clicking) the desired value of input variable in the interactive chart 120 in the desired time interval, or by selecting the input variable in the desired time interval and typing the desired value of the input variable. Defining or adjusting the value of an input variable by adjusting the visualization of the input variable may cause the computing device to automatically reinterpret and re-execute the financial model, which may cause other visualizations in the interactive chart to change. The visualizations of the input variables and the computed variables may be color-coded to the graphical elements that represent such input variables and computed variables.

The interactive table 125 of the graphical user interface 100 may show the values of a selected variable over time (e.g., in monthly periods as depicted). The user may select the variable by selecting the graphical representation of the variable in the electronic canvas 105. Upon selection, the variable and its values may be populated into the interactive chart. The values of the variable may be initialized to zero. Like the interactive table, the interactive chart may enable the user to define or adjust the value of the selected variable in one or more time-intervals. The user can type a desired value into one of the time intervals. The user can apply that value to multiple other time intervals using a click and drag operation. The interactive table 125 may be expandable. That is, the user may expand the interactive table to show two or more variables simultaneously. In some cases, the interactive table may expand to show all of the input variables and computed variables in the financial model.

In some cases, the graphical user interface may have an interactive input form for an input variable. The interactive input form 130 may appear in the graphical user interface upon selection of the graphical element representing the input variable. The interactive input form 130 may enable the user to define or change the name or source of the input variable, as well as multiple time intervals with respective parameters such as initial value, growth rate, growth type, or periodicity of the input variable. The growth type may be for example, linear, exponential, sigmoid, or the like. The initial values of each subsequent time interval may be automatically calculated based on the parameters from its preceding time interval. Changes in this interactive input form may be automatically reflected in the interactive chart 120 as well as the interactive table 125, and vice versa.

The graphical user interface 100 may enable a user to generate a financial report based on the financial model. The financial report may include the interactive chart 120. The financial report may also include numerical metrics derived from the interactive chart. Examples of financial reports include Income Statements, Balance Sheets, Cashflow Statements, and the like. The user can also create custom reports and select which variables should be included in each report. The user can also select the time discretization of each report (e.g. monthly, quarterly, yearly). The graphical use interface 100 may also enable the user to create a report comparing two or more scenarios.

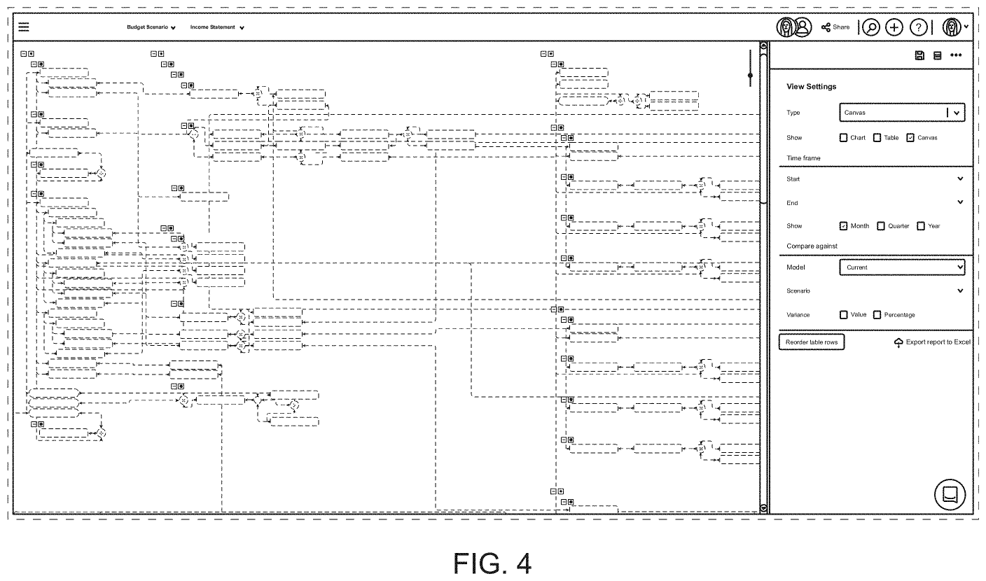

FIG. 4 illustrates a canvas view of the graphical user interface 100 of FIG. 1, according to some embodiments of the present disclosure. In the canvas view, only the electronic canvas 105 is displayed. The interactive chart 120 and the interactive table 125 are omitted. The graphical user interface of FIG. 4 also has a settings panel. The settings panel allows the user to select the view type of the graphical user interface. The user can select any combination of the electronic canvas 105, the interactive chart 120, and the interactive table 125. The settings panel also allows the user to select the time period and the model to be displayed.

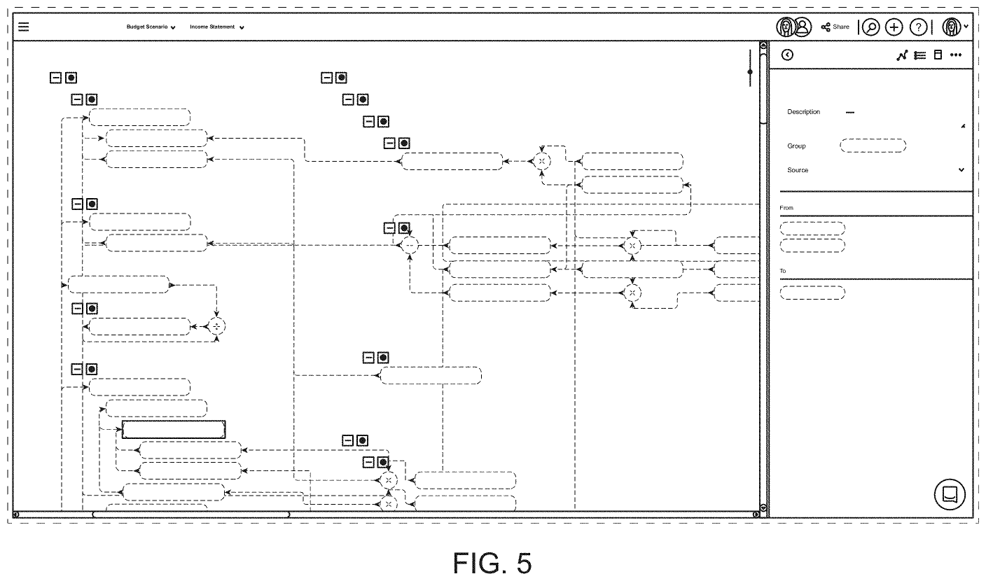

FIG. 5 illustrates an enlarged canvas view of the graphical user interface of FIG. 1 in which a graphical element is selected, according to some embodiments of the present disclosure. When a graphical element is selected, an information panel may appear on the right side of the user interface. The information panel may display a description of the graphical element, a group to which the graphical element belongs, a data source associated with the graphical elements, and other graphical elements connected to the graphical element.

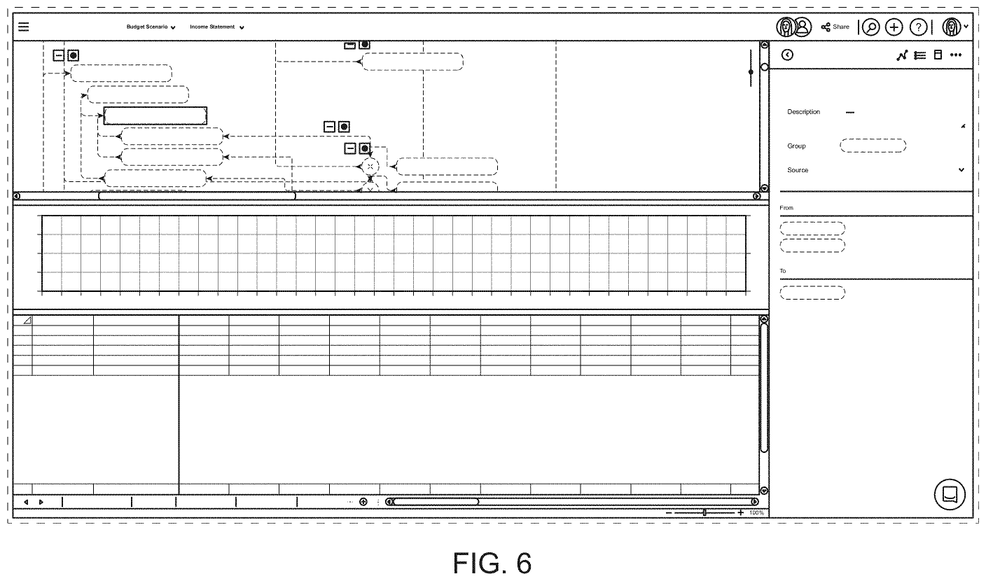

FIG. 6 illustrates an alternative embodiment to the graphical user interface of FIG. 1. In the graphical user interface of FIG. 1, the arrangement of the electronic canvas 105, the interactive chart 120, and the interactive table 125 is different, with the electronic canvas 105 on top.

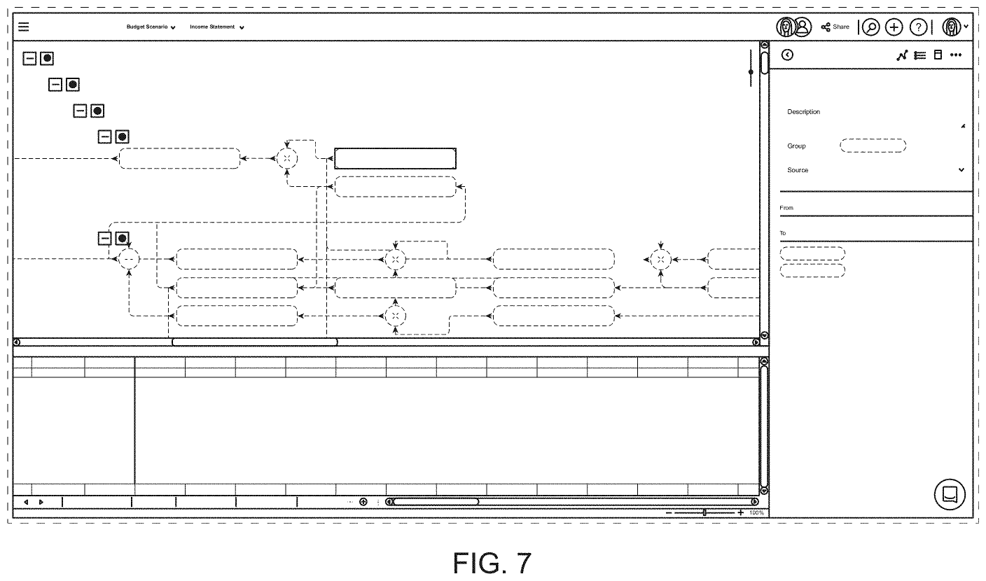

FIG. 7 illustrates a canvas and table view of the of the graphical user interface of FIG. 1, according to some embodiments of the present disclosure. In the canvas and table view, the interactive chart 120 is omitted.

### Financial Modeling Platform

The graphical user interface 100 may be implemented on a platform. The platform may be a cloud computing platform. The platform may be accessible by a plurality of users. The plurality of users may be permitted to edit the graphical representation of the financial model in the electronic canvas 105. The creator of the graphical representation of the financial model can grant the other users permission to view, edit, or comment on the graphical representation of the financial model. The graphical representation of the financial model may be stored in a secure computing environment on the platform. The other users may be required to provide credentials (e.g., an email address and password) in order to access the secure computing environment. The platform may store a history of changes to the graphical representation of the financial model so that the users can track such changes over time.

The platform may enable a user to compare computed variables across different financial models to evaluate the performance of the user's business. The platform may provide access to statistics about computed variables from different financial models. For example, the platform may provide the mean, median, mode, and standard deviation of a computed variable across different financial models. The user may be able to filter such statistics by business size, industry, and other relevant factors. In some cases, the user may be able to view financial models of other businesses that make their financial models available on the platform. Such financial models may be anonymized for privacy purposes.

The platform may generate suggestions for the user based on comparisons between the user's business and similarly situated businesses. The platform may perform a root-cause analysis on a financial model. For example, the platform may perform a regression analysis to determine contributing factors to the user's business's performance.

In some cases, graphical elements used to build a first graphical representation of a first financial model may be usable to build a second graphical representation of a second financial model. Such graphical elements may include individual graphical elements created for the first financial model, collections of graphical elements that represent functions within the first financial model (e.g., a collection of a graphical elements representing a revenue function within an income model), and a graphical element that represents the entire first financial model.

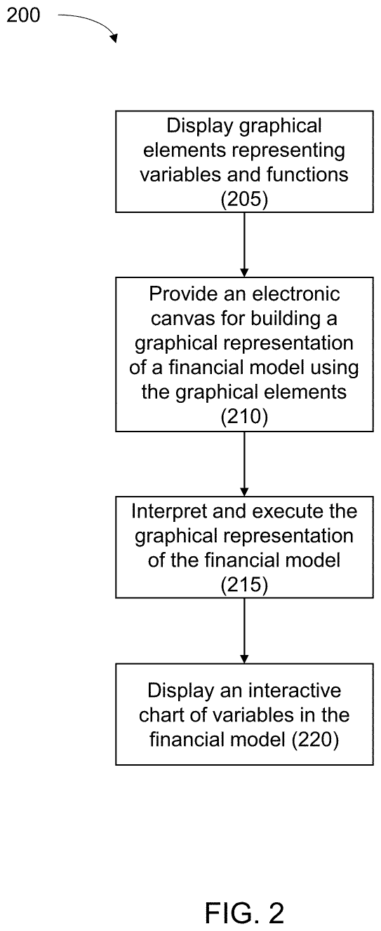

FIG. 2 is a flow chart of an example process 200 for building and displaying a financial model in a graphical user interface. The process 200 can be performed by a system of one or more computers in one or more locations. For example, the computing device that implements that graphical user interface 100 can perform the process 200.

The system can display, in the graphical user interface, a plurality of graphical elements representing a plurality of variables and a plurality of functions (205). The variables may be financial variables. The functions may be mathematical operations or algebraic functions.

The system can provide, in the graphical user interface, an electronic canvas in which to build a graphical representation of the financial model using at least a subset of said plurality of graphical elements (210). The subset of graphical elements may include graphical elements that represent an input variable and a computed variable. The electronic canvas may enable the user to select and connect the subset of graphical elements to build the graphical representation of the financial model. The electronic canvas may be a drag and drop interface. The graphical representation of the financial model may be or resemble a flow chart.

Upon a user building the graphical representation of the financial model in the electronic canvas using the subset of graphical elements, the system can automatically interpret and execute the graphical representation of the financial model to compute the computed variable (215).

The system can display, in the graphical user interface, an interactive chart of the input variable and the computed variable (220). The interactive chart may enable the user to define or adjust at least a value of the input variable. The system can display the electronic canvas and the interactive chart in the graphical user interface simultaneously (e.g., side-by-side or one on top of the other). The interactive chart may have plot lines of the input variable and the computed variable over time. The plot line of the input variable may enable the user to define or adjust the value of the input variable in different time intervals by dragging the plot line. Upon the user adjusting the input variable in such a way, the system can automatically re-execute the financial model and update the interactive chart, including the input variable and any output variables that depend on the input variable, to reflect the adjustment. The plot lines of variables may be color-coded to the graphical elements that represent such variables. In some cases, the interactive chart may have visualizations other than plot lines, e.g., bar charts, histograms, or the like.

The system can additionally display, in the graphical user interface, an interactive table of an input variable upon selection of the graphical element that represents the input variable in the electronic canvas. The interactive table may enable the user to define or adjust the value of the input variable in a plurality of different time intervals.

The system can additionally display, in the graphical user interface, an interactive input form for an input variable upon selection of the graphical element that represents the input variable. The interactive input form may enable the user to define or adjust a name, source, growth rate, growth type, or periodicity of the input variable.

Although the present disclosure primarily describes financial modeling, the systems, methods, and computer program products described herein can be used to create other types of models (e.g., climate models, political models, and the like).

### Computer Systems

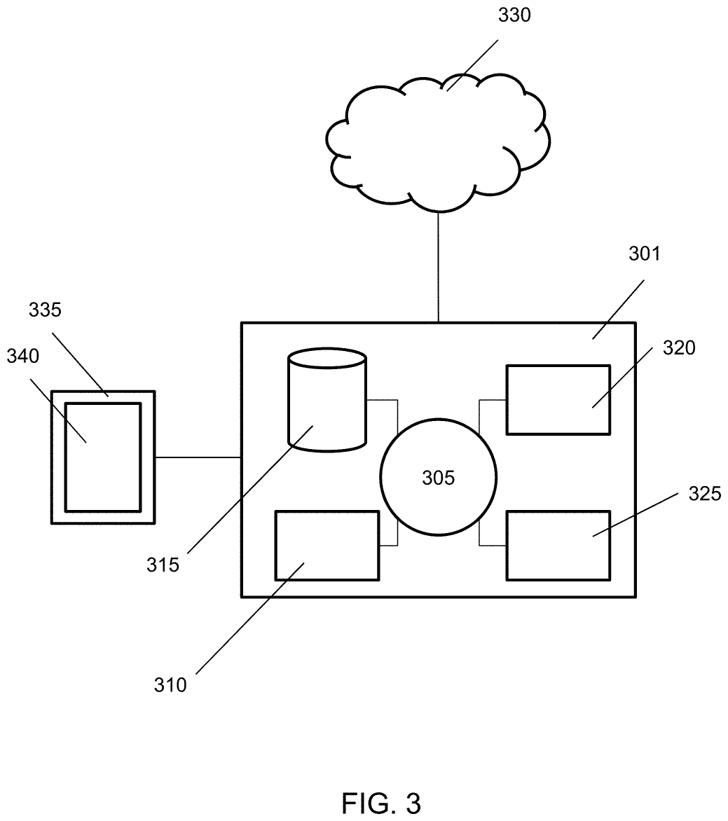

The present disclosure provides computer systems that are programmed to implement methods of the disclosure. FIG. 3 shows a computer system 301 that is programmed or otherwise configured to implement the graphical user interface 100. The computer system 301 can be an electronic device of a user or a computer system that is remotely located with respect to the electronic device. The electronic device can be a mobile electronic device.

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet and/or extranet, or an intranet and/or extranet that is in communication with the Internet. The network 330 in some cases is a telecommunication and/or data network. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback.

The CPU 305 can be part of a circuit, such as an integrated circuit. One or more other components of the system 301 can be included in the circuit. In some cases, the circuit is an application specific integrated circuit (ASIC).

The storage unit 315 can store files, such as drivers, libraries and saved programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine-readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 301 can include or be in communication with an electronic display 335 that comprises a user interface (UI) 340 for providing, for example, the graphical user interface 100 of FIG. 1. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305. The algorithm can, for example, be an algorithm that converts a graphical representation of a financial model into a financial model.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for building and displaying a financial model in a graphical user interface, comprising:
(a) displaying, in said graphical user interface, a plurality of graphical elements representing a plurality of variables and a plurality of functions;
(b) providing, in said graphical user interface, an electronic canvas in which to build a graphical representation of said financial model using at least a subset of said plurality of graphical elements, wherein said subset of graphical elements comprises graphical elements that represent at least an input variable and a computed variable;
(c) upon a user building said graphical representation of said financial model in said electronic canvas using said subset of graphical elements, automatically interpreting and executing said graphical representation of said financial model to compute said computed variable; and
(d) displaying, in said graphical user interface, an interactive chart of said input variable and said computed variable, wherein said interactive chart enables said user to define or adjust at least a value of said input variable.

2. The method of claim 1, further comprising, upon said user adjusting said value of said input variable in said interactive chart, automatically re-executing said financial model and updating said interactive chart to reflect said adjustment.

3. The method of claim 1, further comprising displaying said electronic canvas and said interactive chart in said graphical user interface simultaneously.

4. The method of claim 1, wherein said electronic canvas enables said user to select and connect said subset of graphical elements to build said graphical representation of said financial model.

5. The method of claim 1, wherein said plurality of functions comprises a mathematical operation.

6. The method of claim 1, wherein said plurality of functions comprises an algebraic function.

7. The method of claim 1, wherein said plurality of variables comprises a plurality of financial variables.

8. The method of claim 1, wherein said interactive chart comprises plot lines of said input variable and said computed variable over time.

9. The method of claim 8, wherein said plot line of said input variable enables said user to define or adjust a value of said input variable in a plurality of different time intervals by dragging said plot line of said input variable.

10. The method of claim 8, wherein said plot lines of said input variable and said computed variable are color-coded to said graphical elements that represent said input variable and said computed variable.

11. The method of claim 1, wherein said electronic canvas is a drag and drop interface.

12. The method of claim 1, further comprising, displaying, in said graphical user interface, an interactive table of said input variable upon selection of said graphical element that represents said input variable in said electronic canvas.

13. The method of claim 12, wherein said interactive table enables said user to define or adjust a value of said input variable in a plurality of different time intervals.

14. The method of claim 1, wherein a value of said input variable is obtained from an external data source.

15. The method of claim 1, wherein said graphical representation of said financial model is a flow chart.

16. The method of claim 1, wherein said interactive chart comprises bar charts of said input variable and said computed variable.

17. The method of claim 1, further comprising, displaying in said graphical user interface, an interactive input form for said input variable upon selection of said graphical element that represents said input variable.

18. The method of claim 17, wherein said form enables said user to define or adjust a name, source, growth rate, growth type, or periodicity of said input variable.

19. The method of claim 1, wherein said graphical user interface is implemented on a platform accessible by a plurality of users including said user, wherein each of said plurality of users is permitted to edit said graphical representation of said financial model in said electronic canvas.

20. The method of claim 1, further comprising storing a history of changes to said financial model.

21. The method of claim 1, wherein said subset of graphical elements is reusable to build a plurality of financial models including said financial model.

22. The method of claim 1, further comprising automatically generating a financial report based on said financial model.

23. The method of claim 1, wherein a data structure representation of said financial model is a graph.

24. The method of claim 2, wherein said subset of graphical elements comprises graphical elements that represent a plurality of computed variables, wherein said re-executing comprises determining a subset of said plurality of computed variables that are not affected by said user adjusting said value of said input variable, and wherein said re-executing does not comprise re-computing said subset of computed variables.

25. A system comprising:
one or more computer processors; and
memory comprising machine-executable instructions that, upon execution by said one or more computer processors, cause said one or more computers to perform operations comprising:
displaying, in said graphical user interface, a plurality of graphical elements representing a plurality of variables and a plurality of functions;
providing, in said graphical user interface, an electronic canvas in which to build a graphical representation of said financial model using at least a subset of said plurality of graphical elements, wherein said subset of graphical elements comprises graphical elements that represent at least an input variable and a computed variable;
upon a user building said graphical representation of said financial model in said electronic canvas using said subset of graphical elements, automatically interpreting and executing said graphical representation of said financial model to compute said computed variable; and
displaying, in said graphical user interface, an interactive chart of said input variable and said computed variable, wherein said interactive chart enables said user to define or adjust at least a value of said input variable.

26. One or more non-transitory computer-readable media storing instructions that are operable, when executed by one or more computers, to cause said one or more computers to perform operations comprising:
displaying, in said graphical user interface, a plurality of graphical elements representing a plurality of variables and a plurality of functions;
providing, in said graphical user interface, an electronic canvas in which to build a graphical representation of said financial model using at least a subset of said plurality of graphical elements, wherein said subset of graphical elements comprises graphical elements that represent at least an input variable and a computed variable;
upon a user building said graphical representation of said financial model in said electronic canvas using said subset of graphical elements, automatically interpreting and executing said graphical representation of said financial model to compute said computed variable; and
displaying, in said graphical user interface, an interactive chart of said input variable and said computed variable, wherein said interactive chart enables said user to define or adjust at least a value of said input variable.
